(19) United States
(12) Patent Application Publication
(10) Pub. No.: US 2017/0267188 A1
(43) Pub. Date: Sep. 21, 2017

(54) WEDGE-TYPE MOUNTING DEVICE

(71) Applicant: David Wilkinson, Normandy Park, WA (US)

(72) Inventor: David Wilkinson, Normandy Park, WA (US)

(21) Appl. No.: 15/072,705

(22) Filed: Mar. 17, 2016

(51) Int. Cl. B60R 11/02; B60N 3/10

(52) U.S. Cl. CPC B60R 11/02; B60N 3/103; B60R 2011/0012

(57) ABSTRACT

A mounting device for providing a platform in a motor vehicle between a first seat and a console or a second seat or a in seat-back pocket, wherein the mounting devices includes a plate sized to be received between, and form a frictional or compression engagement with, the first seat and the console or the second seat or within a seat-back pocket of the motor vehicle to facilitate maintenance of the plate in position during normal operation of the motor vehicle; and a mount attached to, and extending away from, the plate and providing a mounting surface to the plate and a fixation arrangement for attachment of an object to the mounting surface. Optionally, a fabric enclosure substantially encloses the plate therein, and the fabric enclosure is optionally a flexible foam fabric enclosure. Optionally, an inflatable bladder is received into the fabric enclosure with the plate.

### FIELD OF THE INVENTION

The present invention relates to a mounting device for a vehicle, and in particular to a mounting device that wedges between a seat and another surface for the purpose of holding an electronic device, cup holder, camera, light, or other apparatus.

### BACKGROUND OF THE INVENTION

Vehicle mounts for electronic device, cup holder, camera, light, or other apparatus are generally well-known. Some such vehicle mounts are glued or otherwise adhered to the vehicle dashboard or attached by suction to the windshield. Others may fit into the vehicle's cup holders, if present. These and other vehicle mounts have known limitations, including weight restrictions and a tendency to become loosened from the vehicle. Other limitations include the mount being only permanently attachable to the vehicle, and so are not movable within the vehicle and remain with the vehicle when the user exits. Accordingly, such known vehicle mounts are limited in their ability to provide efficient and reliable security for the devices they are intended to mount.

### SUMMARY OF THE INVENTION

The present invention is a present invention is a wedge-type mounting device that overcomes limitations of the prior art for providing a mounting platform in a vehicle.

According to one aspect of the invention, the invention is a mounting device for providing a platform in a motor vehicle between a first seat and a console or a second seat or a in seat-back pocket, which includes a plate that is sized to be received between, and form a frictional or compression engagement with, the first seat and the console or the second seat or within a seat-back pocket of the motor vehicle to facilitate maintenance of the plate in position during normal operation of the motor vehicle; and a mount attached to, and extending away from, the plate and comprising a mounting surface to the plate and a fixation arrangement for attachment of an object to the mounting surface.

According to another aspect of the invention, the mounting device of the invention further includes a fabric enclosure that substantially encloses the plate therein.

According to another aspect of the invention, the fabric enclosure of the invention is a flexible foam fabric enclosure.

According to another aspect of the invention, the mounting device of the invention further includes an inflatable bladder that is received into the fabric enclosure with the plate.

According to another aspect of the invention, the plate forms a wedge.

According to another aspect of the invention, the mount is attached at a corner of the plate.

According to another aspect of the invention, the plate is a rectangular plate that is truncated at one corner, and the mount is attached to the truncated corner of the plate.

According to another aspect of the invention, a method of mounting an object in a motor vehicle is provided, wherein the method includes: attaching the object to a mounting surface of a mounting device, wherein the mounting device has a plate and a mount attached to, and extending away from, the plate, and wherein the mount has the mounting surface in fixed arrangement to the plate; and inserting the plate between a first seat and a console or second seat or into a seat-back pocket of the motor vehicle so that the plate forms a frictional or compression engagement with the first seat and console or second seat of the motor vehicle, or with the seat-back pocket; and wherein the frictional or compression engagement between the first seat and console or second seat, or with the seat-back pocket of the motor vehicle is sufficient to maintain the plate and the object attached to the mounting surface in position during normal operation of the motor vehicle.

According to another aspect of the method of the invention, the method further includes inserting the plate into a fabric enclosure prior to inserting the plate between a first seat and a console or second seat of the motor vehicle so that the fabric enclosure forms a frictional interface between the plate and the first seat and the console or second seat of the motor vehicle.

According to another aspect of the method of the invention, the method further includes forming the fabric enclosure of a flexible foam fabric.

According to another aspect of the method of the invention, the method further includes inserting an inflatable bladder into the fabric enclosure with the plate.

According to another aspect of the method of the invention, the method further includes forming the plate in the shape of a wedge.

According to another aspect of the method of the invention, the method further includes attaching the mount at a corner of the plate.

According to another aspect of the method of the invention, the method further includes forming the plate as a rectangular plate having at least one truncated corner, and attaching the mount to the truncated corner of the plate.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates the invention embodied by example and without limitation as a mounting device having a wedge-shaped base that is substantially rigid and is sized to form a frictional or compression engagement with a first seat of a vehicle and a console thereof, or the first seat and a second seat, or within a seat-back pocket of a vehicle to facilitate maintenance of the mounting device in a selected position and orientation during normal operation of the vehicle;

FIG. 2 illustrates the wedge-shaped base of the mounting device of FIG. 1 exclusive of an optional expander and received between the first seat and console of the vehicle;

FIG. 3 illustrates the wedge-shaped base of the mounting device of FIG. 1 including an optional expander and received between the first seat and a second seat of the vehicle with the base positioned and oriented such that a mounting surface of a mount is directed generally forwardly or upwardly (shown) so that user in seat behind is able to either or both observe and operate a portable electronics device mounted thereon;

FIG. 4 illustrates the wedge-shaped base of the mounting device of FIG. 1 received in a pocket on a back of one of the first and second seats with the mounting surface of the mount projected from pocket and directed generally upwardly and backwardly (shown) so that user in a seat behind is able to either or both observe and operate portable electronics device mounted thereon;

FIG. 5 illustrates the wedge-shaped base of the mounting device of FIG. 1 being received between the first seat and either the console or the second seat (omitted for clarity) of the vehicle such that the base of the mounting device is sized to provide maximum frictional engagement between the first seat and either the console or the second seat of the vehicle;

FIG. 6 illustrates the mounting device of FIG. 1 exclusive of the first seat and either the console or the second seat of the vehicle, wherein the mounting device is illustrated with the mount projected from a corner of the wedge-shaped base, and wherein the wedge-shaped base includes a fabric envelope or enclosure that is optionally tailored to contours of the wedge-shape and with the mount extended through an opening thereinto;

FIG. 7 is a cross-section view through the fabric enclosure taken through the mounting device of FIG. 1 as depicted in FIG. 6, wherein the base of the mounting device is illustrated as having a substantially rigid plate with the mount either integral with, or coupled to, a truncated corner of the plate, and the fabric envelope or enclosure is shown in cross-section having an interior pocket that substantially encloses the plate therein with the mount being projected out of the enclosure through the opening thereof, and wherein the enclosure is accessed through a second opening that is sized to receive the plate there through into the interior pocket and a zipper or other closure mechanism is positioned for closing the second opening and substantially enclosing the plate within the enclosure;

FIG. 8 is an exploded view of the mounting device of FIG. 1 with the plate being positioned to be received into the interior pocket of the enclosure, for example, through the optional second opening, if present, an the mount being extended out of the opening of the enclosure, as shown in FIG. 6 and FIG. 7, and the mounting device of FIG. 1 further including the optional expander formed, by example and without limitation, as an optional inflatable bladder that is received into the interior pocket with the rigid plate, and further including an optional filler that is illustrated by example and without limitation as a pad of resiliently compressible material, such as a foam or sponge material, that is received into the interior pocket with the rigid plate for expanding the enclosure into a permanently compressibly expanded state;

FIG. 9 is a cross-section view through the fabric enclosure taken through the mounting device of FIG. 1, wherein the base of the mounting device is illustrated as including the optional inflatable bladder installed within the interior pocket of the fabric envelope or enclosure with the rigid plate, and having the zipper or other closure mechanism closing the second opening and substantially enclosing the plate, the optional filler, and the optional inflatable bladder within the interior pocket of the enclosure and the inflator pump bulb and a portion of a flexible tube being extended outwardly of the enclosure pocket through the opening beside the mount and positioned external of the enclosure, whereby the inflator pump bulb is available for initially inflating the bladder to the inflated state, and subsequently deflating the bladder to the deflated state, and showing a portion of the flexible inflator tube being optionally stowed within the pocket of the enclosure 36;

FIG. 10 is an end view of the assembled mounting device of FIG. 1, wherein the wedge-shaped base includes the optional expander expressed, for example, as the optional inflatable bladder installed with the rigid plate within the interior pocket of the fabric envelope or enclosure and the inflator pump bulb extended outwardly of the enclosure pocket by a portion of the flexible tube through the opening beside the mount, and optionally including the pad filler inserted into the interior pocket of the enclosure in combination with the optional inflatable bladder, and wherein the mounting device is illustrated with the optional inflatable bladder in the deflated state, whereby the fabric enclosure is slack about the deflated bladder and the rigid plate and a base overall thickness of the base is thereby decreased to a minimum;

FIG. 11 is an end view of the assembled mounting device of FIG. 1 as illustrated in FIG. 10, wherein the optional expander is operated for expanding the wedge-shaped base in place, for example, the optional inflatable bladder is installed with the rigid plate within the interior pocket of the fabric envelope or enclosure and the inflator pump bulb is extended outwardly of the enclosure pocket through the opening beside the mount, and wherein the mounting device is illustrated with the optional inflatable bladder in the inflated state, whereby the fabric enclosure is stretched about the inflated bladder and the rigid plate, and the optional pad filler, if present, such that the base overall thickness of the base is expanded toward or completely to a maximum overall thickness;

FIG. 12 illustrates the assembled mounting device 10 of FIG. 1 being positioned between the first and second seats and including the expander formed, for example, as the optional inflatable bladder within the interior pocket of the fabric envelope or enclosure with the rigid plate and having the mount extended outwardly through the opening, and having the wedge-shaped base positioned between the first and second seats with the mount projected from therebetween seats such that the mounting surface is exposed for mounting thereto, and wherein a spacing between the seats is greater than the base overall thickness of the base so that the optional expander is operated to compressibly expand the base overall thickness of the base toward or up to maximum overall thickness by inflating the optional inflatable bladder by means of the inflator pump bulb from the deflated state (FIG. 10) toward its compressibly expanded state (FIG. 11);

FIG. 13 illustrates the mounting device 10 of FIG. 1 with the wedge-shaped base positioned between the first and second seats and having the optional expander formed as the inflatable bladder inserted into the pocket of the enclosure with the plate and being in the uninflated state or underinflated state but capable of expanding in place and temporarily fixedly engaging the first and second seats; and

FIG. 14 illustrates mounting device 10 of FIG. 1 with the wedge-shaped base positioned between the first and second seats and having the expander formed as but not limited to the inflatable bladder inserted into the pocket of the enclosure with the rigid plate and being in the inflated state for expanding in place and temporarily fixedly engaging the first and second seats, wherein the mounting device is initially positioned with the wedge-shaped base between the first seat 14 and second seat with the mount extending away from the base and exposing the mounting surface between the seats, thereafter the inflator is operated for at least partially or fully inflating the inflatable bladder of the expander to its inflated state, thereby the expanding base in place and temporarily fixedly engaging the first and second seats, and an external apparatus is mounted onto the exposed mounting surface of the mount extended from the base.

### DETAILED DESCRIPTION OF PREFERRED EMBODIMENT

As required, a detailed illustrative embodiment of the present protective enclosure is disclosed herein. However, techniques, systems and operating structures in accordance with the present protective enclosure may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present protective enclosure. The following presents a detailed description of an illustrative embodiment (as well as some alternative embodiments) of the present protective enclosure.

In the Figures, like numerals indicate like elements.

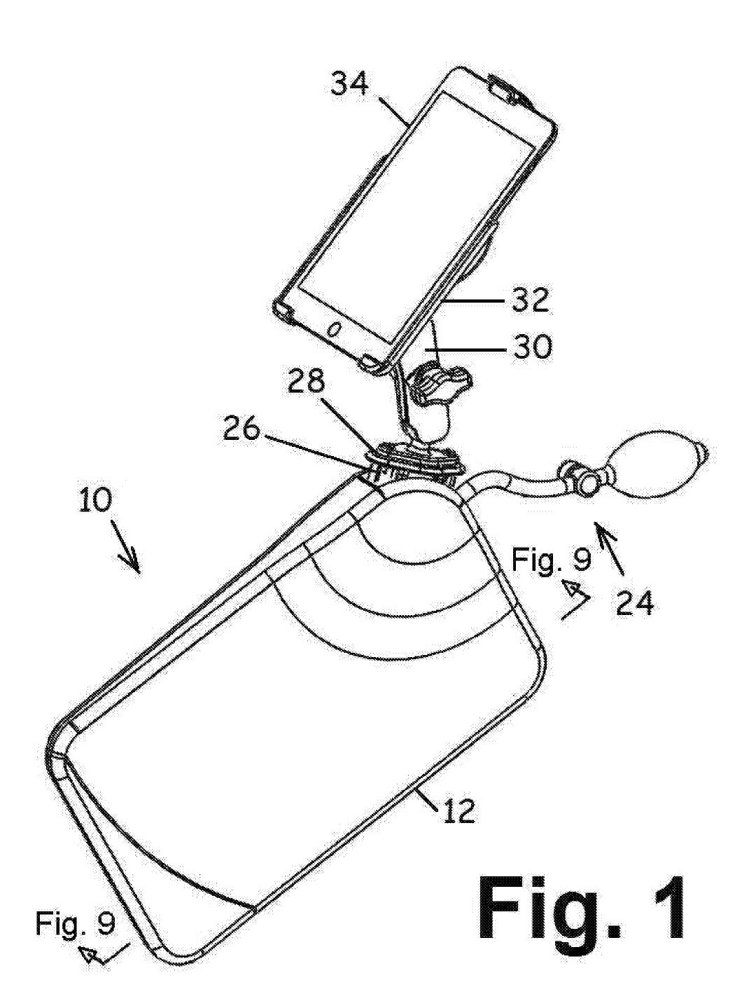

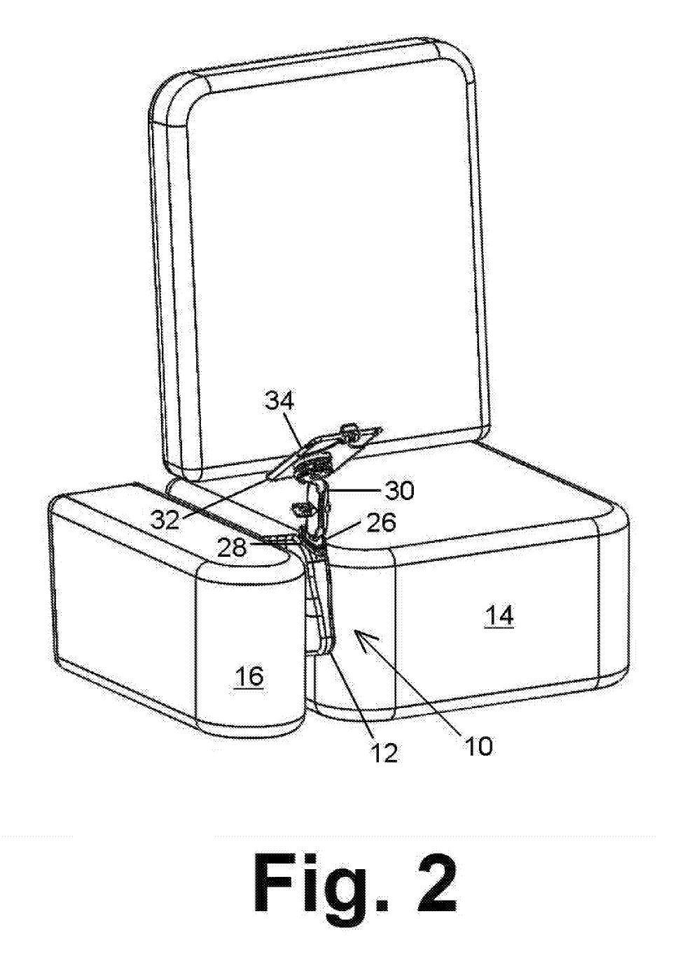

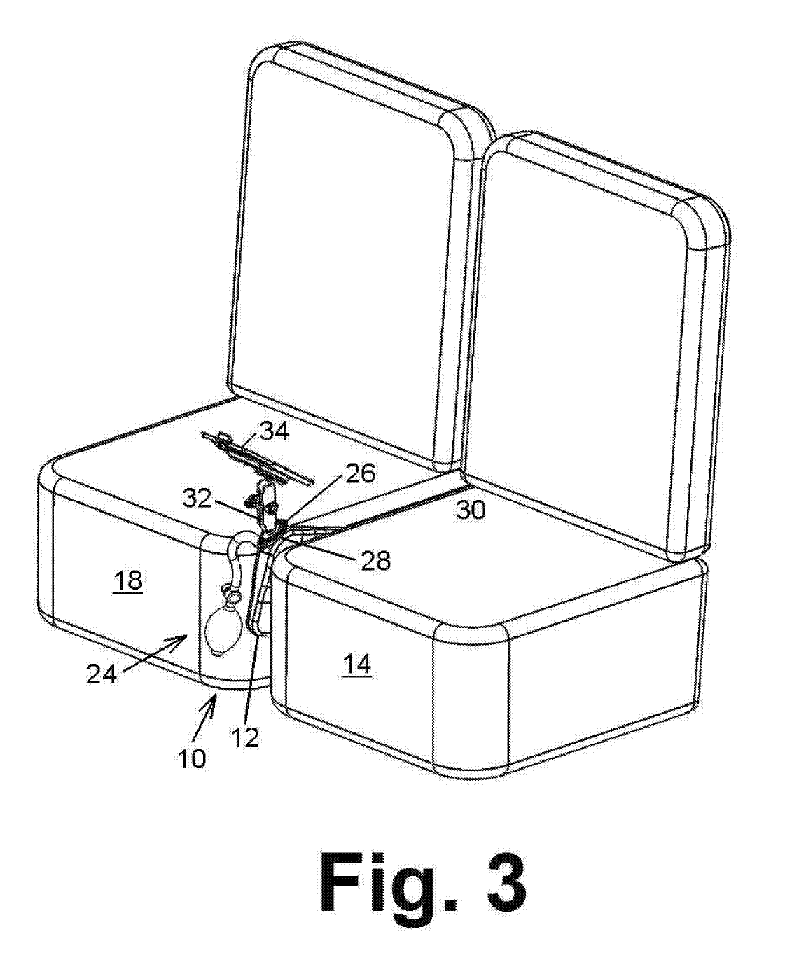

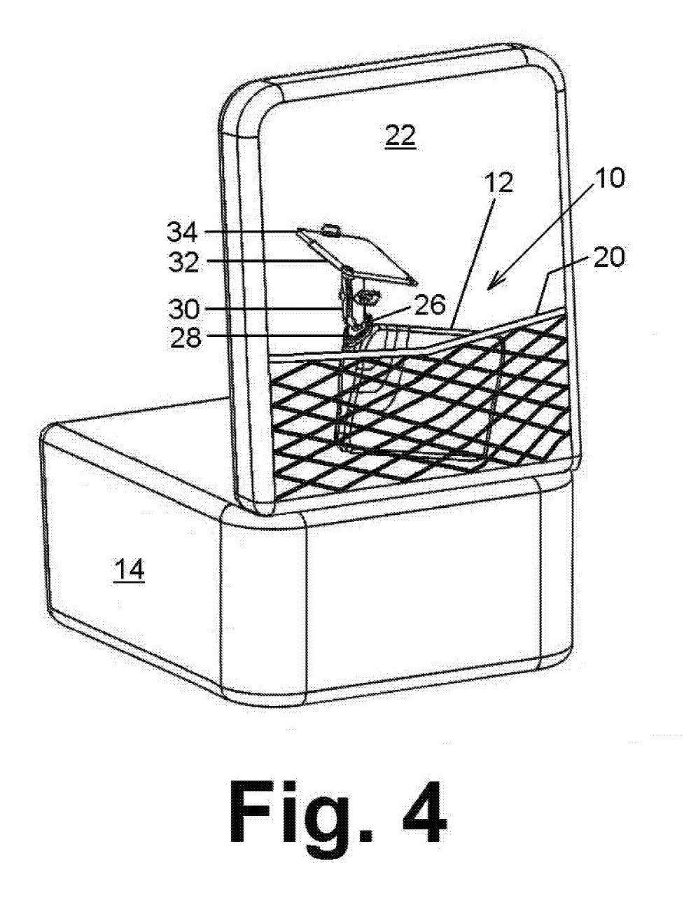

FIG. 1 illustrates the invention embodied by example and without limitation as a mounting device 10 for providing a mounting platform in a vehicle, such as an automobile, aircraft, all-terrain vehicle (ATV), boat, recreational vehicle (RV), truck or other motorized or non-motorized vehicle. For example, mounting device 10 includes a wedge-shaped base 12 that is sized to be received between a first seat 14 and a console 16 (FIG. 2), or between first seat 14 and a second seat 18 (FIG. 3), or in a pocket 20 on a back 22 (FIG. 4) of one of first and second seats 14 or 18.

According to one embodiment, wedge-shaped base 12 of mounting device 10 is substantially rigid and is sized to form a frictional or compression engagement with first seat 14 and the console 16, or first seat 14 and second seat 18, or within seat-back pocket 20 of a vehicle to facilitate maintenance of mounting device 10 in position during normal operation of the vehicle.

Additionally, wedge-shaped base 12 of mounting device 10 optionally includes an expander 24 for expanding in place.

Mounting device 10 includes a mount 26 attached to, and extending away from, wedge-shaped base 12 and having a mounting surface 28 and is a fixation arrangement for attachment of an object to mounting surface 28. For example, mounting surface 28 is optionally extended substantially perpendicular to base 12. Here, by example and without limitation, a ball-and-socket coupler 30 such as but not limited to the device disclosed by the inventor of the instant invention in U.S. Pat. No. 5,845,885 for “Universally Positionable Mounting Device” issued Dec. 8, 1998, and reissued Jan. 25, 2011, as RE42,060, which is incorporated in its entirety herein by reference, is mounted to mounting surface 28 of mount 26. Mount 26 may be utilized to support a cradle 32 such as but not limited to the device disclosed by the inventor of the instant invention in U.S. Pat. No. 8,061,516 for “Portable Device Holder” issued Nov. 22, 2011, which discloses a quick release device holder for cellular telephones and other portable electronics devices 34. Alternatively, other supports and/or holding devices are also contemplated and may be included or substituted without deviating from the scope and intent of the present invention.

FIG. 2 illustrates wedge-shaped base 12 of mounting device 10 exclusive of optional expander 24 and received between first seat 14 and console 16 of a vehicle such as but not limited to an automobile. Rigid base 12 is simply jammed between seat 14 and console 16 with mount 26 projected from between seat 14 and console 16. Base 12 is oriented with mounting surface 28 of mount 26 directed generally forwardly or upwardly (shown) so that user in seat behind is able to either or both observe and operate portable electronics device 34 in cradle 32. Mounting device 10 is held in orientation by friction between wedge-shaped base 12 and one or both of seat 14 and console 16.

FIG. 3 illustrates wedge-shaped base 12 of mounting device 10 received between first seat 14 and second seat 18 of a vehicle such as but not limited to an automobile. Rigid base 12 is simply jammed between seats 14 and 18 with mount 26 projected there between. Base 12 is oriented with mounting surface 28 of mount 26 directed generally forwardly or upwardly (shown) so that user in seat behind is able to either or both observe and operate portable electronics device 34 in cradle 32. Mounting device 10 is held in orientation by friction between wedge-shaped base 12 and one or both of seats 14 and 18. Optional expander 24, if present, is optionally activated to expand base 12, which in turn increases frictional or compression engagement between base 12 and one or both of seats 14 and 18 for resisting changes of both position and orientation of mounting device 10 relative to seats 14, 18.

FIG. 4 illustrates wedge-shaped base 12 of mounting device 10 received in a pocket 20 on a back 22 of one of first and second seats 14, 18. Rigid base 12 is simply received into seat-back pocket 20 on back 22 of either one of first and second seats 14 and 18 with mount 26 projected from pocket 20. Base 12 is oriented with mount 26 directed generally upwardly and backwardly (shown) so that user in seat behind is able to either or both observe and operate portable electronics device 34 in cradle 32. Mounting device 10 is held in orientation by friction between wedge-shaped base 12 and one or both of seat back 22 and pocket 20. As shown, base 12 of mounting device 10 is sized to provide maximum frictional engagement between seat back 22 and pocket 20.

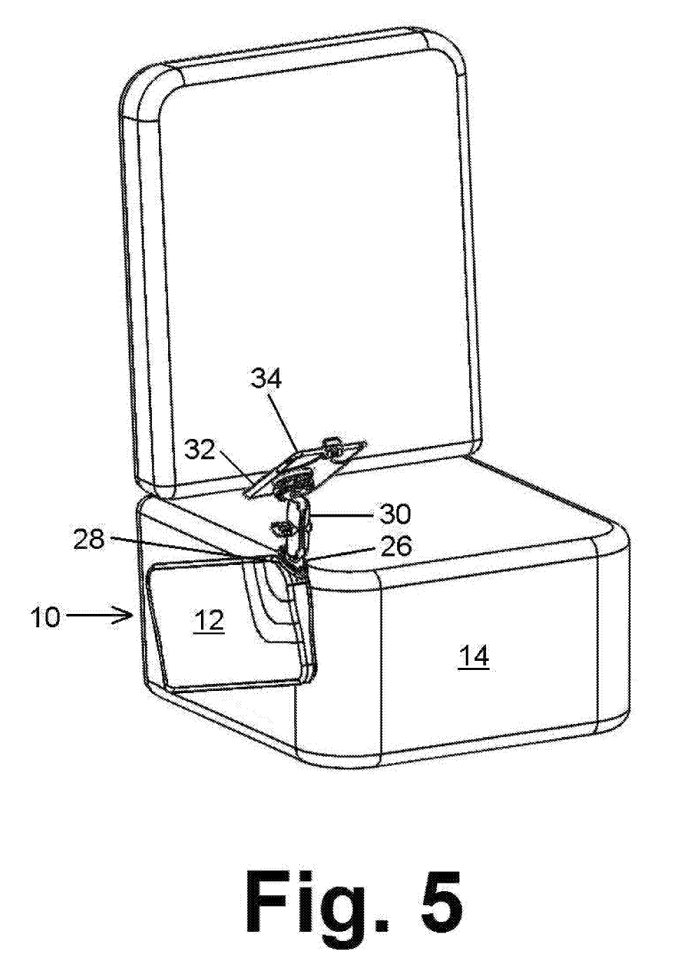

FIG. 5 demonstrates wedge-shaped base 12 of mounting device 10 received between first seat 14 and either console 16 or second seat 18 of a vehicle such as but not limited to an automobile, wherein console 16 and second seat 18 are omitted for clarity. As shown, base 12 of mounting device 10 is sized to provide maximum frictional engagement between first seat 14 and either console 16 or second seat 18 of the vehicle.

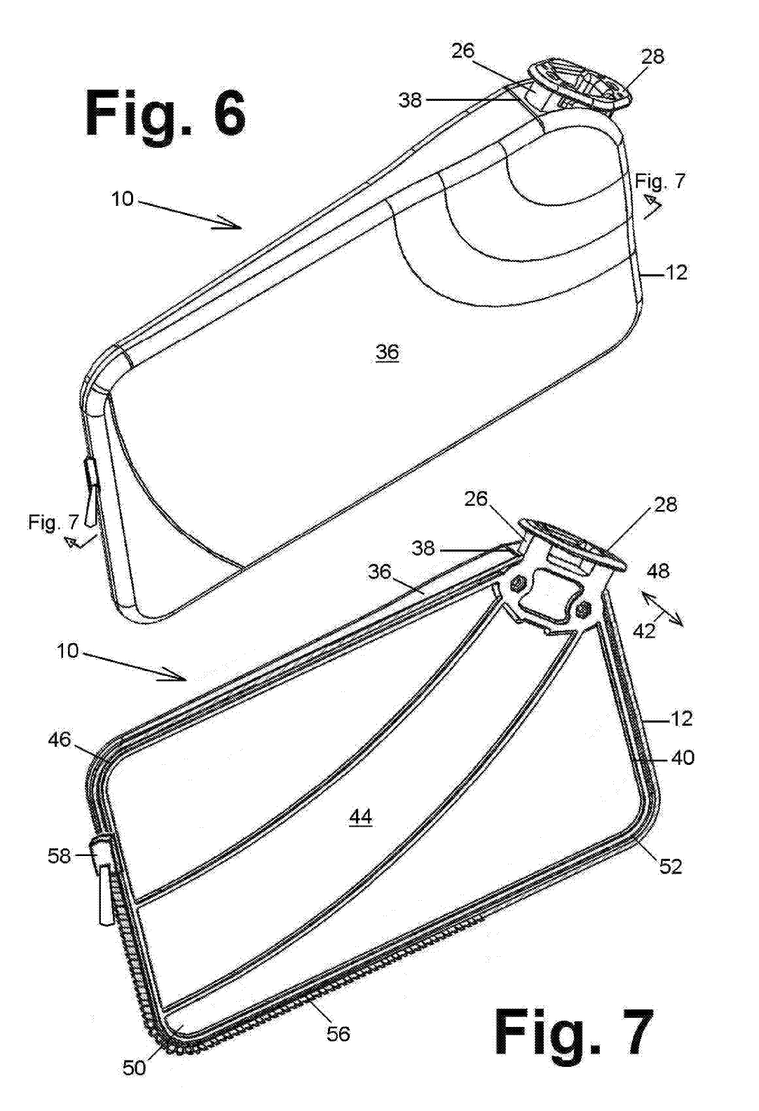

FIG. 6 illustrates mounting device 10 exclusive of first seat 14 and either console 16 or second seat 18 of the vehicle, and having coupler 30 with cradle 32 and portable electronics device 34 all omitted for clarity. Here, mounting device 10 is illustrated with mount 26 projected from a corner of wedge-shaped base 12. According to one embodiment, substantially rigid wedge-shaped base 12 includes a fabric envelope or enclosure 36 with mount 26 extended through an opening 38 thereinto. Fabric enclosure 36 is optionally tailored to contours of wedge-shape, as shown.

FIG. 7 is a cross-section view through fabric enclosure 36 taken through mounting device 10 of FIG. 6, wherein base 12 of mounting device 10 is illustrated as having a substantially rigid plate 40 formed, by example and without limitation, of a plastic, a composite material, or metal. Mount 26 is integral with, or coupled to, plate 40. Optionally, plate 40 is wedge-shaped with a thickness 42 of plate 40 between two opposing sides 44 and 46, with plate thickness 42 tapering between one corner 48 of plate 40 that is thicker than a diagonally opposite thinner corner 50. Optionally, plate 40 is substantially rectangular in shape with thicker corner 48 being truncated and mount 26 projected from truncated corner 48 and extending away from plate 40.

Here, fabric envelope or enclosure 36 is shown in cross-section with an interior pocket 52 substantially enclosing plate 40 therein and having mount 26 of plate 40 projected out of enclosure 36 through opening 38 thereof. Optionally, enclosure 36 includes a second opening 56 that is sized to receive plate 40 there through into interior pocket 52. Optionally, enclosure 36 includes a zipper or other closure mechanism 58 positioned for closing second opening 56 and substantially enclosing plate 40 within enclosure 36.

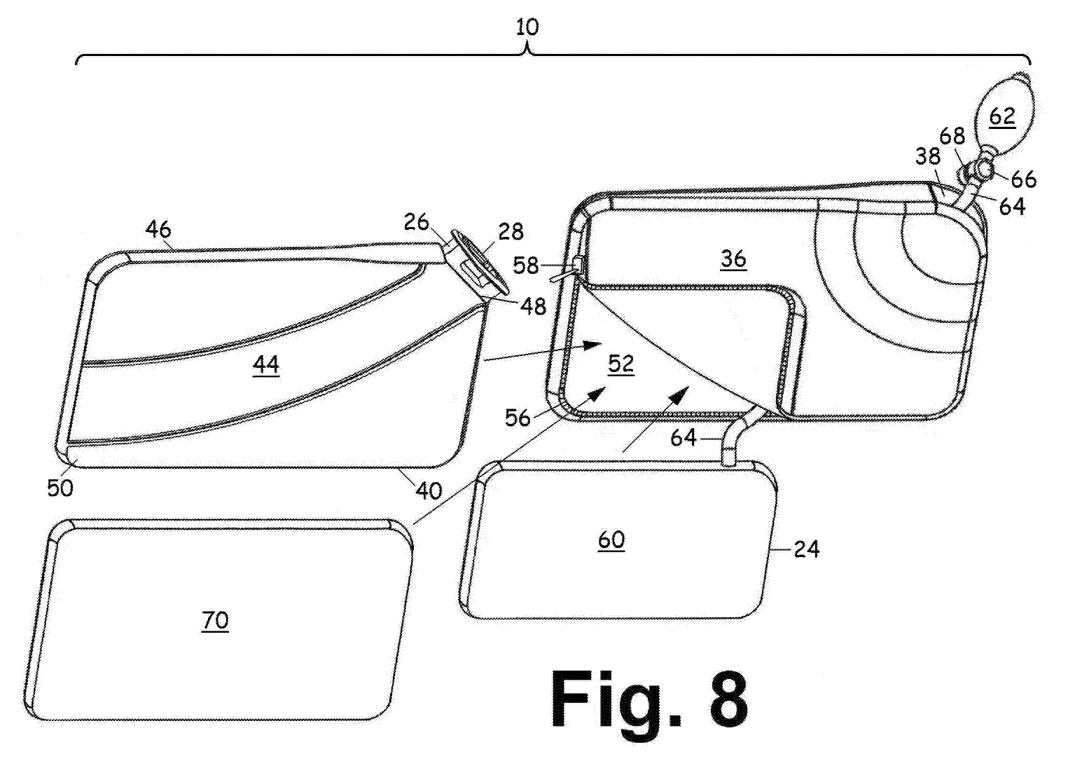

FIG. 8 is an exploded view of mounting device 10 with plate 40 positioned to be received into interior pocket 52 of enclosure 36, for example, through optional second opening 56, if present. With plate 40 received into interior pocket 52, mount 26 is extended out of opening 38 of enclosure 36, as shown in FIG. 6 and FIG. 7.

Here, by example and without limitation, optional expander 24 of wedge-shaped base 12 may be an inflatable bladder 60 that is received into interior pocket 52 with rigid plate 40, by example and without limitation on either side 44 or 46 thereof. When received into pocket 52, for example, through optional second opening 56, if present, optional inflatable bladder 60 is substantially enclosed therein with plate 40. By example and without limitation, optional bladder 60 of expander 24 includes an inflation mechanism or inflator 62, such as a pump bulb coupled to inflatable bladder 60 though a flexible inflator tube 64, for forcing an inflationary fluid, such as air or liquid, into bladder 60, for example, through flexible tube 64, whereby optional bladder 60 is filled to an inflated state. When optional bladder 60 is brought to an inflated state enclosure 36 is enlarged into a temporarily expanded state.

Expander 24 includes a valve or other anti-deflation device 66 positioned for preventing loss of inflation and subsequent deflation of optional bladder 60 from the inflated state. A valve or other deflation device 68 is also positioned for allowing loss of inflationary fluid from optional bladder 60 and subsequent deflating of bladder 60 from the inflated state to a deflated state. When optional bladder 60 of expander 24 is emptied to its deflated state enclosure 36 is shrunk to a temporarily shrunken state. Optionally, valve or other anti-deflation device 66 includes pressure release capability such that anti-deflation device 66 is structured to operate as pressure release device 68 for deflating optional bladder 60. As illustrated, inflator 62 and a portion of flexible inflator tube 64 adjacent thereto is extended outwardly of interior pocket 52 through opening 38 of enclosure 36.

Wedge-shaped base 12 may include an optional filler 70 that is received into interior pocket 52 of enclosure 36 with rigid plate 40, by example and without limitation on either side 44 or 46 thereof. When received into pocket 52, for example, through optional second opening 56, if present, optional filler 70 is substantially enclosed therein with plate 40. By example and without limitation, optional filler 70 is pad of resiliently compressible material, such as a foam or sponge material, for expanding enclosure 36 into a permanently compressibly expanded state. Optional pad filler 70 is optionally inserted into interior pocket 52 of enclosure 36 either alone or in combination with optional inflatable bladder 60. Optional pad filler 70 may be inserted either on the same or opposite side 44 or 46 as optional inflatable bladder 60 when present.

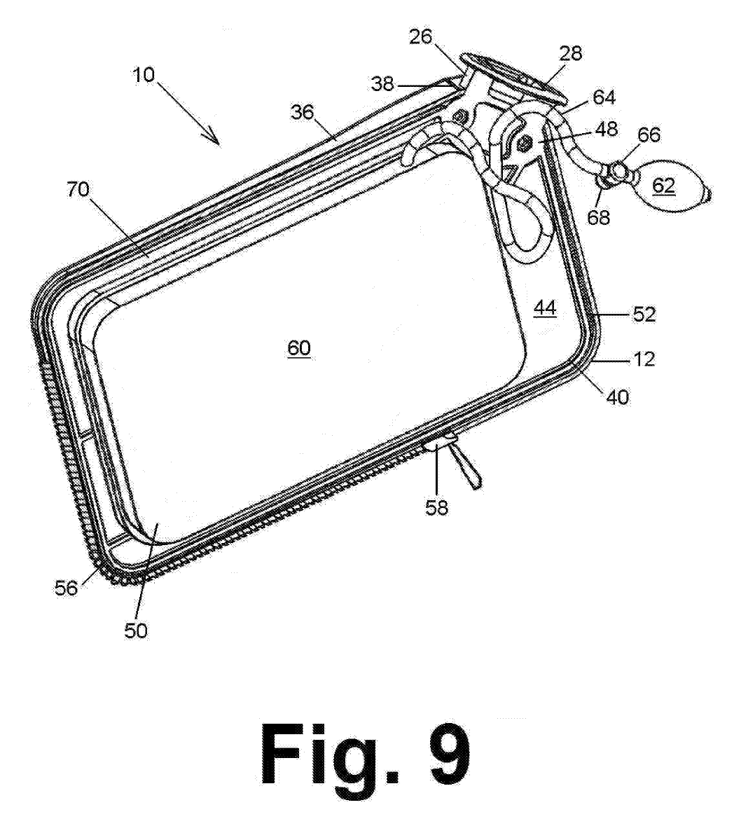

FIG. 9 is a cross-section view through fabric enclosure 36 taken through assembled mounting device 10 of FIG. 1, wherein base 12 of mounting device 10 is illustrated as including optional inflatable bladder 60 installed within interior pocket 52 of fabric envelope or enclosure 36 with rigid plate 40, and having zipper or other closure mechanism 58 closing second opening 56 and substantially enclosing both plate 40 and optional inflatable bladder 60 within interior pocket 52 of enclosure 36. Inflator pump bulb 62 and a portion of flexible tube 64 may be extended outwardly of enclosure pocket 52 through opening 38 beside mount 26 and positioned external of enclosure 36, whereby inflator pump bulb 62 is available for initially inflating bladder 60 to the inflated state, and subsequently deflating bladder 60 to the deflated state. Optionally, a portion of flexible inflator tube 64 is stowed within pocket 52 of enclosure 36, as illustrated.

Here, base 12 of mounting device 10 is illustrated as further including optional filler 70 inserted into interior pocket 52 of fabric envelope or enclosure 36, for example, between optional inflatable bladder 60 and rigid plate 40. Obviously, order of position of optional filler 70 and optional inflatable bladder 60 relative to rigid plate 40 within interior pocket 52 of enclosure 36 is optional and does not significantly affect operation of mounting device 10.

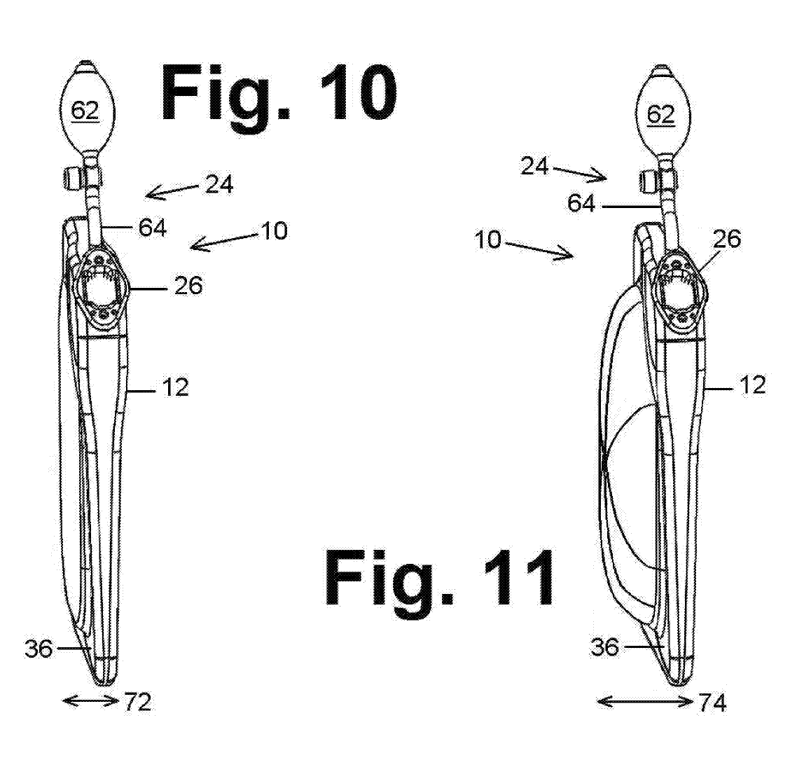

FIG. 10 is an end view of assembled mounting device 10 of FIG. 1, wherein wedge-shaped base 12 includes optional expander 24 for expanding in place. For example, optional inflatable bladder 60 is installed with rigid plate 40 within interior pocket 52 of fabric envelope or enclosure 36 and inflator pump bulb 62 with a portion of flexible tube 64 is extended outwardly of enclosure pocket 52 through opening 38 beside mount 26, as disclosed herein. Mounting device 10 optionally includes pad filler 70 inserted into interior pocket 52 of enclosure 36 in combination with optional inflatable bladder 60. Here, mounting device 10 is illustrated with optional inflatable bladder 60 in the deflated state, whereby fabric enclosure 36 is slack about deflated bladder 60 and rigid plate 40 and a base overall thickness 72 of base 12 is decreased to a minimum.

FIG. 11 is an end view of assembled mounting device 10 of FIG. 1 as illustrated in FIG. 10, wherein optional expander 24 is provided for expanding wedge-shaped base 12 in place. For example, optional inflatable bladder 60 is installed with rigid plate 40 within interior pocket 52 of fabric envelope or enclosure 36 and inflator pump bulb 62 with a portion of flexible tube 64 is extended outwardly of enclosure pocket 52 through opening 38 beside mount 26, as disclosed herein. Here, mounting device 10 is illustrated with optional inflatable bladder 60 in the inflated state, whereby fabric enclosure 36 is stretched about inflated bladder 60 and rigid plate 40 and base overall thickness 72 of base 12 is expanded toward or completely to a maximum overall thickness 74.

When optional pad filler 70 is inserted into interior pocket 52 of enclosure 36 in combination with optional inflatable bladder 60, maximum overall thickness 74 of base 12 is increased over inflating of bladder 60 alone.

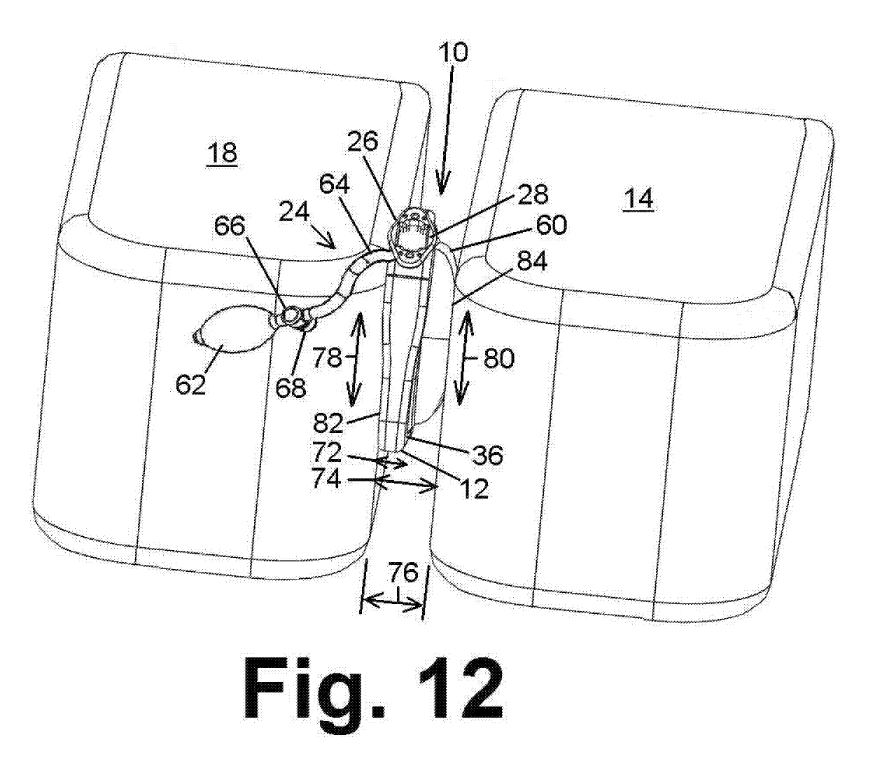

FIG. 12 illustrates assembled mounting device 10 of FIG. 1 positioned between first and second seats 14, 18. Here, base 12 of mounting device 10 is illustrated as including expander 24. For example, optional inflatable bladder 60 is installed within interior pocket 52 of fabric envelope or enclosure 36 with rigid plate 40 with mount 26 extended outwardly of enclosure pocket 52 through opening 38, as disclosed herein. Wedge-shaped base 12 is positioned between first and second seats 14, 18 with mount 26 projected from between seats 14, 18, such that mounting surface 28 is exposed for mounting thereto.

When seats 14, 18, or seat 14 and console 16 (FIG. 2), are spaced (arrow 76) close together, i.e., closer than either thickness 42 of wedge-shaped plate 40 alone, or wedge-shaped plate 40 plus optional filler 70, when present, base 12 may be jammed between seat 14 and console 16 or seat 18 and will be retained in selected position and orientation by frictional forces (arrows 78 and 80) between fabric envelope or enclosure 36 and each of seat 14 and console 16 or seat 18. For example, enclosure 36 is optionally formed of a flexible foam fabric having a high coefficient of surface friction, or a loop or other surface, rather than a smooth, shiny surface such as satin.

When spacing 76 between seats 14, 18, or seat 14 and console 16 (FIG. 2) is greater than base overall thickness 72 of base 12 or otherwise insufficient to retain selected position and/or orientation of mounting device 10 by frictional forces (arrows 78 and 80) between fabric envelope or enclosure 36 of base 12, with or without optional filler 70, and each of seat 14 and console 16 or seat 18, optional expander 24 may be operated to compressibly expand base overall thickness 72 of base 12 toward or up to maximum overall thickness 74. When optional expander 24 is present, with optional inflatable bladder 60 in the deflated state, base 12 of mounting device 10 is placed between seats 14, 18, or seat 14 and console 16 (FIG. 2), or within seat-back pocket 20, in a selected position and orientation. When present, optional expander 24 is then operated by inflating optional inflatable bladder 60 by means of inflator pump bulb 62 from the deflated state (FIG. 10) toward its compressibly expanded state (FIG. 11).

When base overall thickness 72 is maximized toward overall thickness 74, outer surfaces 82 and 84 of fabric enclosure 36 of base 12 are forcibly pressed against seats 14, 18, or seat 14 and console 16 (FIG. 2), or seat-back 22 and pocket 20 (FIG. 4), to provide compression engagement between more widely spaced 76 first seat 14 and the console 16, or first seat 14 and second seat 18, or seat-back 22 and pocket 20. Frictional forces (arrows 78 and 80) are maximized by such compression engagement between fabric envelope or enclosure 36 and each of seats 14, 18, or seat 14 and console 16 (FIG. 2), or seat-back 22 and pocket 20 (FIG. 4) for temporarily retaining selected position and/or orientation of mounting device 10.

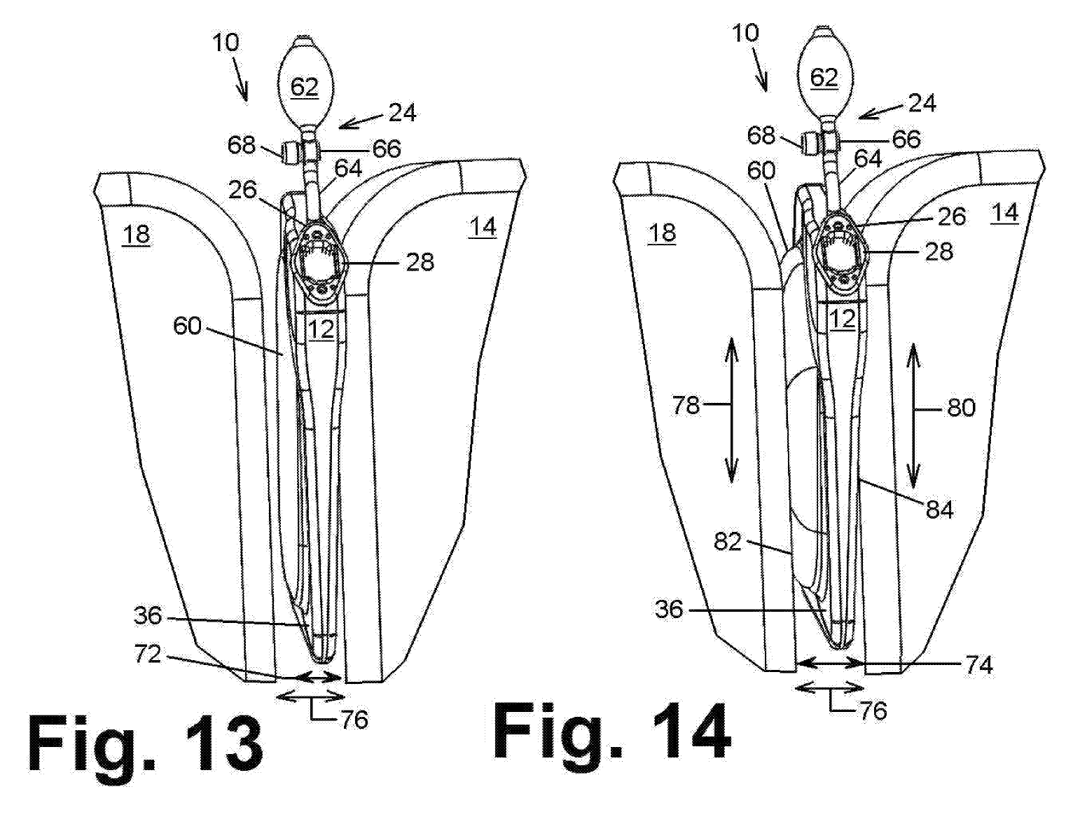

FIG. 13 illustrates mounting device 10 of FIG. 1 with wedge-shaped base 12 positioned between first seat 14 and console 16 (FIG. 2), or between first seat 14 and second seat 18 (FIG. 3), or in pocket 20 on back 22 (FIG. 4) of one of first and second seats 14 or 18. Here, mounting device 10 is illustrated by example and without limitation as having expander 24, such as but not limited to optional inflatable bladder 60 inserted into pocket 52 with substantially rigid plate 40. Here, optional inflatable bladder 60 is in the uninflated state or an underinflated state such that base overall thickness 72 is narrower than space 76 between first and second seats 14, 18. However, expander 24 is capable of expanding base overall thickness 72 of wedge-shaped base 12 in place and temporarily fixedly engaging first seat 14 and console 16 (FIG. 2), or first seat 14 and second seat 18 (FIG. 3), or seat pocket 20 and back 22 (FIG. 4) of one of first and second seats 14 or 18 as disclosed herein.

Wedge-shaped base 12 may include an optional filler 70 that is received into interior pocket 52 of enclosure 36 with rigid plate 40 and optional inflatable bladder 60.

Mounting device 10 is positioned, as illustrated in each of FIG. 2, FIG. 3, and FIG. 4, with wedge-shaped base 12 between first seat 14 and console 16, or between first seat 14 and second seat 18, or in seat pocket 20 with mount 26 attached thereto extending away from base 12 such that mounting surface 28 is exposed for mounting an external apparatus thereon, such as but not limited to ball-and-socket coupler 30 illustrate in FIG. 1.

FIG. 14 illustrates mounting device 10 of FIG. 1 with wedge-shaped base 12 positioned between first seat 14 and console 16 (FIG. 2), or between first seat 14 and second seat 18 (FIG. 3), or in pocket 20 on back 22 (FIG. 4) of one of first and second seats 14 or 18, as illustrated in FIG. 13. Here, mounting device 10 is illustrated by example and without limitation as having expander 24, such as but not limited to optional inflatable bladder 60 inserted into pocket 52 with substantially rigid plate 40 and being in the inflated state for expanding in place and temporarily fixedly engaging first seat 14 and console 16 (FIG. 2), or first seat 14 and second seat 18 (FIG. 3), or seat pocket 20 and back 22 (FIG. 4) of one of first and second seats 14 or 18 as disclosed herein. For example, mounting device 10 is initially positioned, as illustrated in one of FIG. 2, FIG. 3, and FIG. 4, with wedge-shaped base 12 between first seat 14 and console 16, or between first seat 14 and second seat 18, or in seat pocket 20 with mount 26 attached thereto extending away from base 12 such that mounting surface 28 is exposed for mounting an external apparatus thereon, such as but not limited to ball-and-socket coupler 30 illustrate in FIG. 1. Inflator 62 is then operated for at least partially or fully inflating optional inflatable bladder 60 of expander 24 to its inflated state, thereby expanding base 12 in place and temporarily fixedly engaging first seat 14 and console 16 (FIG. 2), or first seat 14 and second seat 18 (FIG. 3), or seat pocket 20 and back 22 (FIG. 4) of one of first and second seats 14 or 18 as disclosed herein.

Thereafter, or at any previous time, an external apparatus, such as but not limited to ball-and-socket coupler 30 illustrate in FIG. 1, is mounted onto exposed mounting surface 28 of mount 26 extended from base 12.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1: A mounting device for providing a platform in a motor vehicle between a first seat and a console or a second seat or a in seat-back pocket, comprising:
a plate sized to be received between, and form a frictional or compression engagement with, the first seat and the console or the second seat or within a seat-back pocket of the motor vehicle to facilitate maintenance of the plate in position during normal operation of the motor vehicle; and
a mount attached to, and extending away from, the plate and comprising a mounting surface to the plate and a fixation arrangement for attachment of an object to the mounting surface.

2: The mounting device of claim 1, further comprising a fabric enclosure substantially enclosing the plate therein.

3: The mounting device of claim 1, wherein the fabric enclosure further comprises a flexible foam fabric enclosure.

4: The mounting device of claim 3, further comprising an inflatable bladder received into the fabric enclosure with the plate.

5: The mounting device of claim 1, wherein the plate forms a wedge.

6: The mounting device of claim 1, wherein the mount is attached at a corner of the plate.

7: The mounting device of claim 6, wherein the plate further comprises a rectangular plate truncated at one corner, and the mount is attached to the truncated corner of the plate.

8: A method of mounting an object in a motor vehicle, the method comprising:
attaching the object to a mounting surface of a mounting device, the mounting device further comprising a plate and a mount attached to, and extending away from, the plate, wherein the mount comprises the mounting surface in fixed arrangement to the plate; and
inserting the plate between a first seat and a console or second seat or into a seat-back pocket of the motor vehicle so that the plate forms a frictional or compression engagement with the first seat and console or second seat of the motor vehicle, or with the seat-back pocket;
wherein the frictional or compression engagement between the first seat and console or second seat, or with the seat-back pocket of the motor vehicle is sufficient to maintain the plate and the object attached to the mounting surface in position during normal operation of the motor vehicle.

9: The method of claim 8, further comprising inserting the plate into a fabric enclosure prior to inserting the plate between a first seat and a console or second seat of the motor vehicle so that the fabric enclosure forms a frictional interface between the plate and the first seat and the console or second seat of the motor vehicle.

10: The method of claim 8, further comprising forming the fabric enclosure of a flexible foam fabric.

11: The method of claim 10, further comprising inserting an inflatable bladder into the fabric enclosure with the plate.

12: The method of claim 8, further comprising forming the plate in the form of a wedge.

13: The method of claim 8, further comprising attaching the mount at a corner of the plate.

14: The method of claim 13, further comprising forming the plate as a rectangular plate having at least one truncated corner, and attaching the mount to the truncated corner of the plate.

15: A mounting device for providing a platform in a vehicle using a seat and console wedge feature, a first and second seat wedge feature, or a seat-back pocket wedge feature, the mounting device comprising:
a plate comprising two opposing side walls joined by an edge wall, wherein each of the side walls has a lengthwise extent and a height wise extent, wherein the side walls are spaced apart by a thickness that is less than each of the lengthwise extent and the height wise extent of the side walls; and
a mount positioned adjacent to the edge wall with a mounting surface thereof directed away from the plate; and
wherein the plate is sized to be received between one of: a seat and a center console, a first and second seat, or a seat-back pocket residing in an automobile and oriented with the mount projected from between the seat and center console, the first and second seat, or the seat-back pocket.

16: The mounting device of claim 15, further comprising a fabric envelope substantially enclosing the plate therein.

17: The mounting device of claim 16, wherein the fabric envelope further comprises a flexible foam fabric envelope.

18: The mounting device of claim 3, further comprising an inflatable bladder substantially enclosed in the fabric envelope with the plate.
